(19) United States
(12) Patent Application Publication
(10) Pub. No.: US 2005/0011905 A1
(43) Pub. Date: Jan. 20, 2005

(54) Heat-resistant baking and serving dish

(76) Inventor: Christiane Baum, Louisville, KY (US)

Correspondence Address: FULBRIGHT & JAWORSKI, LLP, 666 FIFTH AVE, NEW YORK, NY, 10103-3198, US

(21) Appl. No.: 10/679,958

(22) Filed: Oct. 6, 2003

(30) Foreign Application Priority Data
Jul. 18, 2003 (DE) 103 32 659.6

(51) Int. Cl. A47J 29/00

(52) U.S. Cl. 220/912

(57) ABSTRACT

A heat-resistant baking and serving dish 1 made of glass or glass ceramic 1 has edges 3, 4 on two opposite sides, the distance A between the edges corresponding to the distance K between supports 10, 11 in a refrigerator 7, so that the dish 1 can be slid on the edges 3, 4 onto the supports 10, 11.

### BACKGROUND AND SUMMARY OF THE INVENTION

The invention relates to a heat-resistant baking and serving dish made of glass or glass ceramic for the preparation of foods.

Such dishes are known in which foods may be boiled, roasted, and served. Such a dish is described in Schott Info, Das Spezialglas-Magazin [The Specialty Glass Magazine] No. 100, 1-2002, page 30.

The object of the present invention is to improve the functionality of the dish so that foods may also be cooled in the dish.

According to the invention, the object described above is achieved by the fact that the dish has edges on two opposite sides, the distance between the edges corresponding to the distance between supports in a refrigerator, so that the dish can be slid on the edges onto the supports. In this manner the dish may be put directly into a refrigerator instead of onto a shelf, and is supported on its edges by the supports in the refrigerator. Available supports can thus be used without having to place the dish on a shelf of the refrigerator. The dish makes advantageous use of the width of the refrigerator.

The dish may be used for boiling, roasting, grilling, cooling, and freezing of foods, and may be used for cooling or freezing the foods before or after they are prepared.

For example, the food can be arranged in the dish, refrigerated, and then at a desired time baked in the oven, roasted, or boiled in the dish, and subsequently served in the dish. It is not necessary to transfer the food to other containers between heating procedures. This simplifies work and reduces the amount of washing required.

Altogether, the increased functionality results in better hygiene and improved logistics and protection of the environment. Such dishes can be used in the household as well as in commercial kitchens and catering operations.

The lateral edges and/or a rear edge of the dish preferably have openings for air circulation in the refrigerator which enable the cooling air to be drawn downward through the openings in the dish. Air circulation can also be ensured by spacers provided on the dish which face the inner rear wall of the refrigerator.

The dish is preferably provided with a lid which prevents the food from drying out in the refrigerator. The lid may also have the same shape as the dish. The dish and/or lid may be provided with commercial logos and/or decorations and/or lettering.

One exemplary embodiment is described below.

### BRIEF DESCRIPTION OF THE FIGURES

FIG. 1 shows a schematic view of the interior of a refrigerator with a baking and serving dish inserted;

FIG. 2 shows a view of a refrigerator insert with a baking and serving dish to be inserted;

FIG. 3 shows the baking and serving dish placed on the insert;

FIG. 4 shows the baking and serving dish inserted into an oven;

FIG. 5 shows the baking and serving dish set into an oven rack; and

FIG. 6 shows the baking and serving dish placed on an oven rack.

### DETAILED DESCRIPTION

A heat-resistant baking and serving dish 1 made of glass, in particular a borosilicate glass, or glass ceramic has edges 3, 4, 5, 6 which border a recess 2. Recess 2 is used to hold foods. Edges 3, 4 and 5, 6 run in pairs essentially parallel to one another. The corner regions of the edges are rounded. In known designs of such a baking and serving dish 1 (see Schott Info No. 100, 1-2002), the edges and their distances from one another are designed with respect to an attractive shape and ease of handling. The edges are not used for insertion into a refrigerator. If a dish 1 of known design is to be put into a refrigerator, it must be placed on a shelf or rack therein. The dish sits upright on the shelf or rack, and the available free space next to the dish is usable only to a very limited extent.

A commercially available refrigerator 7 has on its lateral inner walls 8, 9 multiple oppositely situated supports 10, 11 used to support shelves and racks (not shown) at different heights.

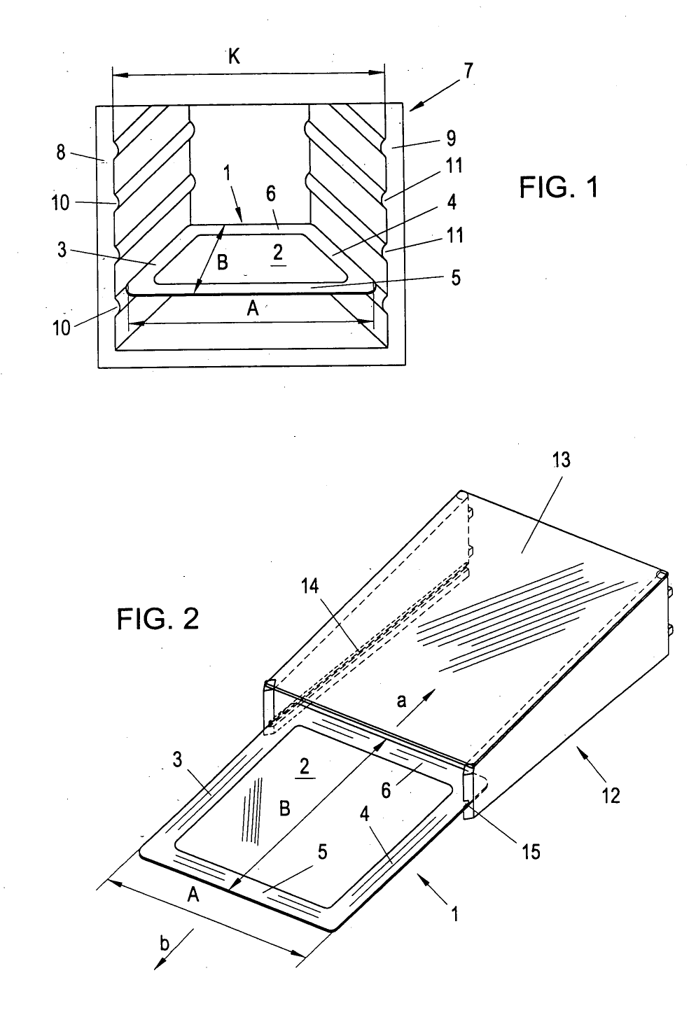

To enable dish 1 to make advantageous use of inner refrigerator width K, distance A between edges 3, 4 of the dish is designed so that said distance corresponds to inner refrigerator width K, i.e., the distance between supports 10, 11. Dish 1 can thus be slid directly onto supports 10, 11 from the front and is borne by supports 10, 11 without the need for a shelf or rack. This is shown in FIG. 1.

For very large refrigerator widths, it may be impractical to design dish 1 to be large enough that distance A between its edges 3, 4 corresponds to the very large refrigerator width K. For such wide refrigerators, frame-shaped inserts 12 for subdividing the width of the refrigerator are available which are attachable to the rear wall of the refrigerator. A glass plate 13 rests upon insert 12. A holding compartment is situated below glass plate 13.

Channel-shaped supports 14, 15 may be provided on insert 12 underneath glass plate 13 into which dish 1 may be pushed in, in the direction of arrow a, or pulled out, in the direction of arrow b, on its edges 3, 4 (see FIG. 2). Glass plate 13 provides covered protection of dish 1 and the food therein. Other goods can be stored on glass plate 13.

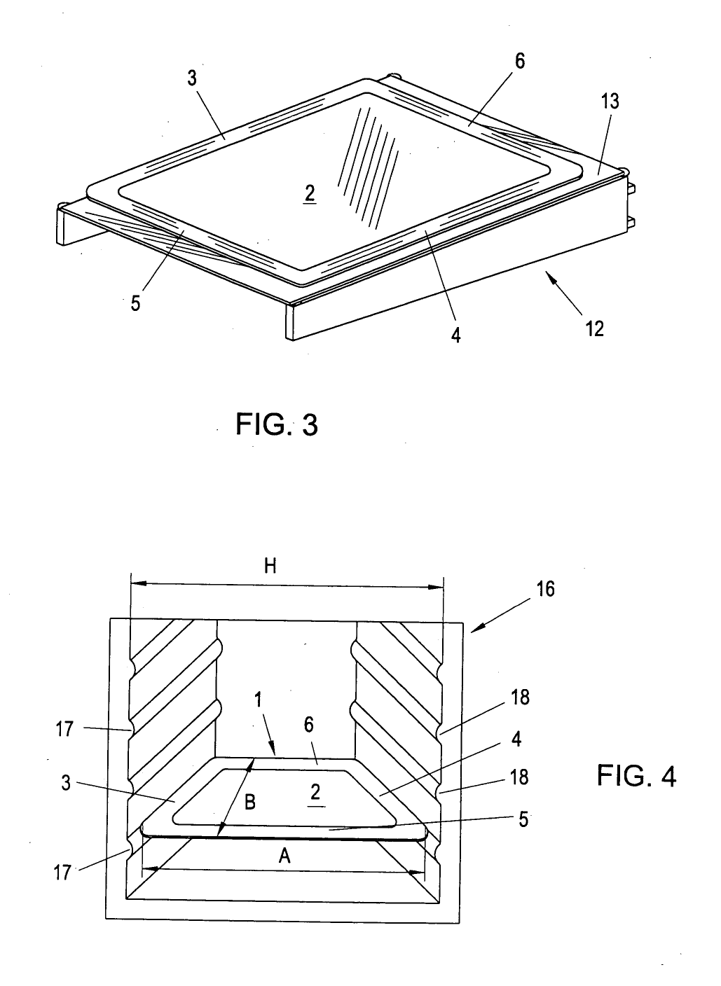

In another application (see FIG. 3), dish 1 can be placed on glass plate 13.

Dish 1, for which the distance between its edges 3, 4 is adjusted to refrigerator 7, can be inserted directly into an oven 16, in particular on supports 17, 18 of same, when distance H between supports 17, 18 is the same as distance A between edges 3, 4 (see FIG. 4), or is the same as distance B between edges 5, 6 of dish 1.

If oven 16 is significantly wider, and thus distance H is significantly greater than distances A or B, dish 1 can be inserted into oven 16 when supported by an oven rack 19. Oven rack 19 is dimensioned so that it can be slid on supports 17, 18.

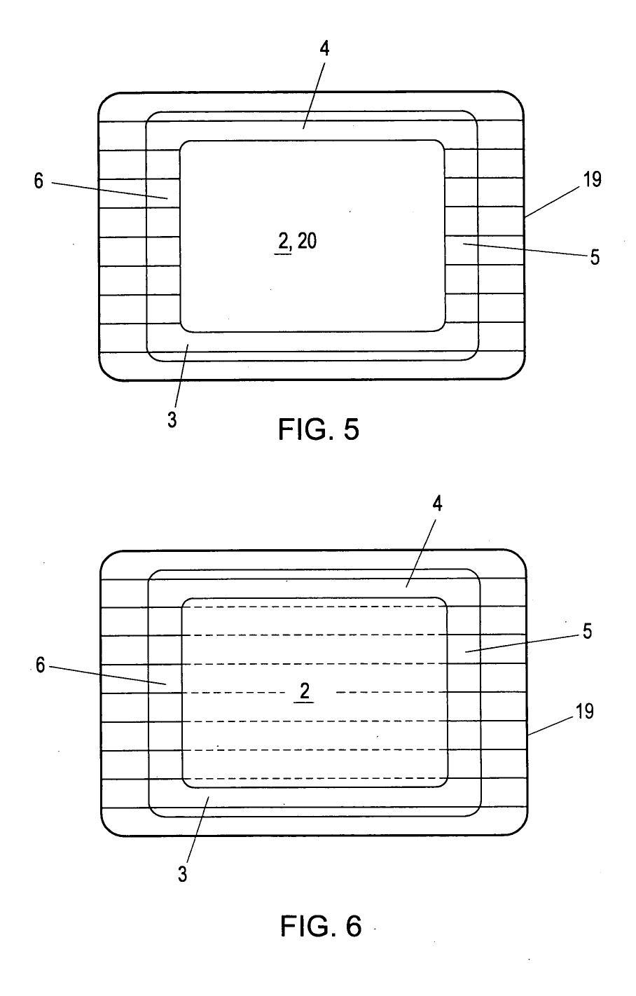

Oven rack 19 may have an indentation 20 into which recess 2 of dish 1 fits, whereby edges 3, 4, 5, 6 rest on oven rack 19 (see FIG. 5).

If oven rack 19 has no indentation 20, dish 1 may be placed on the oven rack (see FIG. 6).

Edges 3, 4, 5, 6, in particular lateral edges 3, 4 and/or rear edge 6, may be provided with openings to prevent dish 1 from blocking the air circulation in refrigerator 7. For the same purpose, spacers may be provided on dish 1 which face the rear wall of refrigerator 7 and which are designed as one or more projections on edge 6 or as an undulated shape of edge 6. For reasons of symmetry, front edge 5 preferably has the same design as rear edge 6.

Dish 1 may be provided with a lid, not shown, which can be placed on edges 3, 4, 5, 6. The lid can have the same shape as dish 1, and may be designed so that additional goods can be placed thereon in refrigerator 7.

Dish 1 may be provided with commercial logos and/or decorations and/or lettering, in particular on one or more of its edges 3 through 6.

1. A heat-resistant baking and serving dish made of glass or glass ceramic for the preparation of foods,
the dish comprising on two opposite sides, the distance between the edges corresponding to the distance between supports in a refrigerator, so that the dish can be slid on the edges onto the supports.

2. A dish according to claim 1, wherein the supports are provided on the inner walls of the refrigerator.

3. A dish according to claim 1, wherein the supports are provided on an insert which can be inserted in the refrigerator.

4. A dish according to claim 1, wherein at least one of lateral edge and a rear edge of the dish have openings for the circulation of air in the refrigerator.

5. A dish according to claim 2, wherein at least one of lateral edge and a rear edge of the dish have openings for the circulation of air in the refrigerator.

6. A dish according to claim 3, wherein at least one of lateral edge and a rear edge of the dish have openings for the circulation of air in the refrigerator.

7. A dish according to claim 1, wherein spacers are provided on the dish which face the inner rear wall of the refrigerator.

8. A dish according to claim 2, wherein spacers are provided on the dish which face the inner rear wall of the refrigerator.

9. A dish according to claim 3, wherein spacers are provided on the dish which face the inner rear wall of the refrigerator.

10. A dish according to claim 4, wherein spacers are provided on the dish which face the inner rear wall of the refrigerator.

11. A dish according to claim 1, wherein the dish has a lid.

12. A dish according to claim 2, wherein the dish has a lid.

13. A dish according to claim 3, wherein the dish has a lid

14. A dish according to claim 4, wherein the dish has a lid.

15. A dish according to claim 11, wherein the lid has the same shape as the dish.

16. A dish according to claim 12, wherein the lid has the same shape as the dish.

17. A dish according to claim 1, wherein the distances between the edges of the dish are dimensioned so that the edges rest on an oven rack next to an indentation in same, whereby a recess in the dish projects into the indentation.

18. A dish according to claim 2, wherein the distances between the edges of the dish are dimensioned so that the edges rest on an oven rack next to an indentation in same, whereby a recess in the dish projects into the indentation.

19. A dish according to claim 1, wherein the dish is provided with at least one of a commercial logo, a decoration and lettering.

20. A dish according to claim 2, wherein the dish is provided with at least one of a commercial logo, a decoration and lettering.
